(19) United States
(12) Patent Application Publication
(10) Pub. No.: US 2007/0136079 A1
(43) Pub. Date: Jun. 14, 2007

(54) Method and system for planned transportation cross-docking

(75) Inventors: Martin Beykirch, Sandhausen (DE); Volker Barth, Wiesloch (DE); Andreas Gnacke, Achern-Gamshurst (DE); Thomas Christ, Kronau (DE); Wolfgang E. Walter, Hambruecken (DE); Amar Kumar, Neulussheim (DE); Christian Reinhardt, Mannheim (DE)

Correspondence Address: SAP/BLAKELY, 12400 WILSHIRE BOULEVARD, SEVENTH FLOOR, LOS ANGELES, CA, 90025-1030, US

(73) Assignee: SAP AG

(21) Appl. No.: 11/297,976

(22) Filed: Dec. 8, 2005

(51) Int. Cl. G06Q 99/00

(52) U.S. Cl. 705/1

(57) ABSTRACT

A system and method are provided for planned transportation cross-docking. A predetermined route for transportation of goods from a source location to an intermediate location to a destination location is provided. A document associated with goods is generated. The document indicates the predetermined route and includes cross-docking at the intermediate location.

### FIELD

Embodiments of the invention relate to supply chain management. More specifically, embodiments of the invention relate to planned transportation cross-docking.

### BACKGROUND

Transportation and warehousing have been an integral part of supply chain management (SCM). For example, SCM software available from SAP AG of Walldorf, Germany, provides transportation, warehousing and storage of goods. Transportation and warehousing are used together to provide a technique not only to transport goods, but also to process goods at various distribution centers and warehouses. However, the conventional ways of transportation and warehousing are commonly based on distribution systems that rely on ongoing demands after the allocated material from the incoming stock has already arrived at a warehouse (or has been even put away at a warehouse). In other words, conventional distribution systems are limited to transporting and processing of goods of the already arrived stock based on changing demands as they become known.

Further, with the increase in companies wanting to have their distribution systems provide higher service levels and better delivery times, the conventional distribution system-related problems (e.g., complicated and long routes, storing and repacking of goods, unpredictability, etc.) are further exacerbated, resulting in even more cumbersome and inefficient distribution of goods.

### SUMMARY

A system and method are provided for planned transportation cross-docking. A predetermined route for transportation of goods from one or more source locations to one or more intermediate locations to one or more destination locations is provided. A document associated with goods is generated. The document includes a stock transport order (STO). The STO may indicate the predetermined route and include cross-docking at one or more intermediate locations.

### BRIEF DESCRIPTION OF DRAWINGS

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 illustrates one embodiment of a planned transportation cross-docking route and TCD document flow.

FIG. 2 illustrates one embodiment of an organizational structure for transportation cross-docking.

FIG. 3 illustrates an embodiment of a transactional sequence for transportation cross-docking.

FIG. 4 illustrates an embodiment of a route for transportation cross-docking.

FIG. 5 illustrates an embodiment of a process for generation of a warehouse task and allocation of goods using transportation cross-docking mapping data.

FIG. 6 illustrates an embodiment of transportation cross-docking management.

### DETAILED DESCRIPTION

As used herein, references to one or more “embodiments” are understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive. Descriptions of certain details and implementations follow, including a description of the figures, which may depict some or all of the embodiments described below, as well as discussing other potential embodiments or implementations of the inventive concepts presented herein.

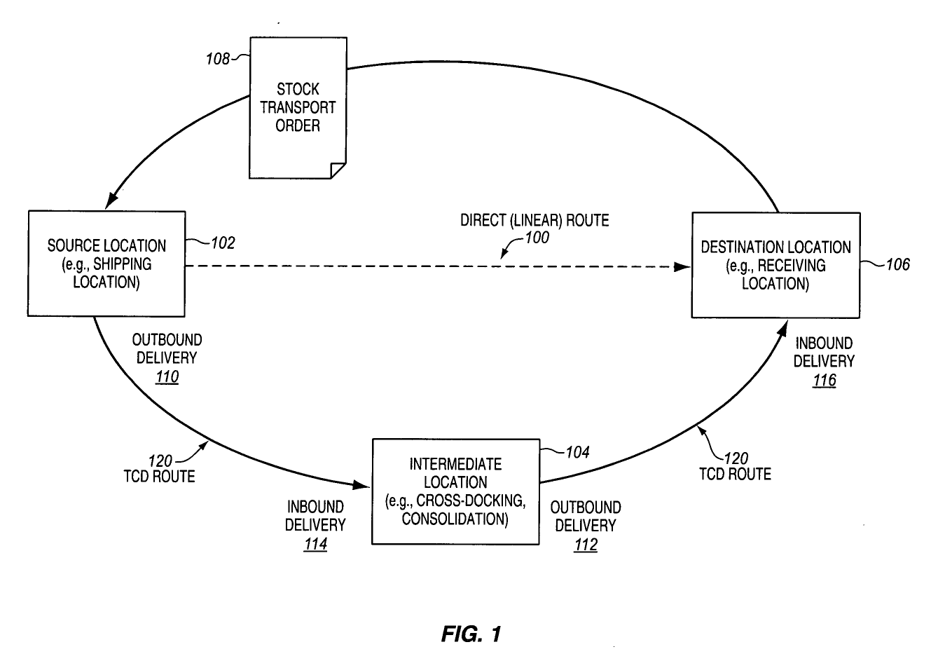

FIG. 1 illustrates one embodiment of a planned transportation cross-docking (TCD). In one embodiment, TCD provides for “planning” of a transportation of goods (e.g., product, article of manufacture, package, stock, load, material, shipment, etc.) from a source location 102 (e.g., source facility, initial facility, shipping location, shipping warehouse, first location, shipper, etc.) to a destination location 106 (e.g., destination facility, final facility, receiving location, receiving warehouse, last location, customer, etc.) via an intermediate location 104 (e.g., intermediate facility, intermediate location, cross-docking location, cross-docking warehouse, etc.) using a document, such as STO 108 (e.g., document, e-document, routing document, sales order (SO), etc.). Similarly, another form of document, such as a sales order, may also be used, in which case the final receipt is the customer. For brevity and clarity, STO 108 is used here as an example, but the same or similar techniques may also be applicable when using another document, such as an SO. For example, STO 108, which is generated using TCD management, may not take direct or linear route 100 from source location 102 to destination location 106, but may direct the goods from source location 102 to destination location 106 via TCD route 120. Using an STO 108, the incoming shipment is planned to be cross-docked at a given intermediate location 104 prior to the actual shipment of goods. In one embodiment, the goods are not put away in storage bins at intermediate location 104, but they are cross-docked directly (at intermediate location 104) and sent to final destination location 106.

One TCD routing path or route 120 is shown beginning with source location 102, which represents a beginning point or shipping location for the movement of goods. STO 108 may be generated with respect to goods for movement along the TCD route 120. In one embodiment, movement of goods along route 120 is according to a routing plan, meaning a predetermined, prescribed, and organized plan of movement and schedule of locations through which goods are expected to pass to arrive at destination location 106 when coming from source 102 as indicated by STO 108. This planning of TCD route 120 helps avoid the spontaneous and opportunistic movement of goods which can be costly, untimely, and inefficient. This planning of TCD route 120 may be a predetermined sequence of events and/or locations, which may be based on a number of factors. Examples of such factors include, but are not limited to, layout of warehouses at various locations 102-106, availability of such warehouses (e.g., available only from 5 PM-7 AM), types of goods (e.g., fragile, perishable, bulky, oversized, heavy, etc.), history of goods, customer history, route history, weather, international borders, etc. For example, physical mapping of a warehouse may determine that a certain location, such as intermediate location 104, is necessary for goods to pass through to arrive at another intermediate location or destination location 106. However, in one embodiment, in planned TCD, these and other factors are known and TCD route 120 is predetermined using the knowledge of these factors.

STO 108 may be generated to indicate the movement of goods from source location 102 to destination location 106 via intermediate location 104. In one embodiment, the movement of goods may initiate from one or more source locations, pass through one or more intermediate locations, and arrive at one or more destination locations. An intermediate location 104 may include a warehouse or any type of processing station, and may include, among others, a goods receipt (GR) zone, a goods issued (GI) zone, a counting station, a deconsolidation station, a picking zone, a packing station, a staging area, etc. When multiple intermediate locations 104 are involved, each of them may differ depending on whether goods are being received or shipped out, upon the type of goods, routing path or routing plan, customer or supplier, etc. In one embodiment, STO 108 may be associated with goods, meaning that the movement of goods may be described, directed, indicated and/or tracked by STO 108. For example, STO 108 may indicate the movement of goods from source location 102 to destination location 106 via intermediate location 104 and cross-docking and consolidation of goods at intermediate location 104. In one embodiment, STO 108 remains unchanged and instead, outbound and inbound deliveries 110-116 are created. For example, as illustrated, outbound delivery 110 is created coming out of source location 102 and inbound delivery 116 is generated going into destination location 106. Similarly, inbound delivery 114 and outbound delivery 112 are created going into and coming out of intermediate location 104, respectively.

Goods represent any type of goods, products, materials, items of manufacture, etc. Examples of goods may include anything from eggs or furniture to screws or heavy equipment to motors or drive assemblies, and the like. The warehouse-based processing that may be performed on each item may differ, depending on the type of goods, even within the same warehouse. For example, batteries could be received, counted, and tested at intermediate location 104, while door assemblies may be received, counted, checked for uniformity, sanded, and painted at intermediate location 104.

In one embodiment, TCD route 120 is planned according to an expected or historically-known sequence of events that may influence the movement of some or all goods. For example, a particular route or a detour to a particular warehouse at a certain cross-docking intermediate location may be scheduled for particular items or classes of items, such as bolts, nuts, screws, nails, rivets, etc., may be regarded as a different class of goods than items like fenders, doors, hoods, side panels, etc. Thus, a different process or route or sub-route may exist for the different classes of goods, such as a master route 120 or master routing plan or standard plan or global plan may be planned for goods, but for transporting particular goods or a particular class of goods, certain events or warehouses or locations may be removed from or added to the master route 120.

TCD provides functions for planning and optimizing of transportation of goods from source location 102 to destination location 106 via intermediate location 104 prior to the actual transportation of goods, which helps support warehouse processing of goods at intermediate location warehouses without the need for storage or repacking of such goods. Also, in planned TCD, since deliveries of goods are predetermined and planned, the corresponding documents for each inbound delivery 114-116 are matched to documents for each corresponding outbound delivery 110-112. Stated differently, each item of an outbound delivery 110-112 is matched with each item of the corresponding inbound delivery 114-116 to help achieve planned transportation, including cross-docking and consolidation, of goods within TCD route 120. This is in contrast with unplanned or opportunistic distribution systems, in which transportation opportunities are detected for in an unpredictable environment, leading to increasing storage costs, delays, and lack of proper time management. Furthermore, in planned TCD, the shipment of goods is not posted financially to destination location's inventory and the owner of the shipment remains the original owner as at source location 102. Although the shipped goods may not be presented in the material master of intermediate location 104, it is permitted to be cross-docked at intermediate location 104. Also, the financial posting occurs once the material is received at the final location, such as when the goods are received at destination location 106.

For brevity and clarity, merely three locations 102-106 are illustrated. In one embodiment, however, multiple source locations, intermediate locations, and destination locations may be planned to be part of a routing path depending on various factors (e.g., type or class of goods, history of goods, customer requests, etc., as described elsewhere in this document). For example, a TCD route may be predetermined as follows: from Boise, Id. (source location) to Casper, Wyo. (first intermediate location) to Denver, Colo. (second intermediate location) to Colorado Springs, Colo. (third intermediate location) to Dallas, Tex. (destination location). Furthermore, in one embodiment, not all locations have to be in the same country (e.g., United States of America) as, for example, a destination location may be in another country (e.g., Mexico). For example, if a destination location is in Mexico City, Mexico, using the same example as above, Dallas may be regarded as the forth and last intermediate location prior to reaching destination location in Mexico City, or it may be regarded as another destination location (e.g., first destination location) along with the other destination location (e.g., second destination location) that is in Mexico City, Mexico. Also, in this case, the USA-Mexico international border is to be crossed, which may require necessary documents, processes, and/or procedures (e.g., predetermined alteration of route, supplemental STOs, additional cross-docking, additional consolidation, etc.).

In one embodiment, handling units (HUs) may be used for actual transportation of goods within a TCD route 120. An HU consists of packaging material and the material contained therein. Once an HU has been defined, it can be used to execute the movement of goods as indicated by STO 108. HUs can also help simplify various transportation processes. An HU represents one or more items of one or multiple goods for routing. For example, HU may include a vehicle (e.g., a truck), a package, a box, a pallet of knobs, etc. The size of HUs may depend upon the particular warehouse, the purpose of the move, the size of an incoming or outgoing shipment, etc. HUs are not necessarily homogeneous, although they may be. HUs may include a single part type or all parts for one or more assemblies. In a planned TCD, an HU may be moved or transferred from one location to another 102-104-106 without being stored or put-away. HUs may have various smaller HUs contained therein (e.g., a box within a box), which means there can be various levels of HUs. A cross-dock outer HU that includes multiple inner HUs is properly labeled, as the inner HUs are also properly labeled and consolidated into the outer HU. Each of the HU is pre-labeled with standard HU information (e.g., weight, quantity, name and location of the destination facility, etc.) before any of the HUs are moved. These HUs are transported, monitored, tracked, etc., by transportation cross-docking management and as indicated by STO 108.

For example, TCD may employ HUs to facilitate transportation of goods from source location 102 to destination location 106 via intermediate location 104. This movement of HUs is planned and predetermined by TCD management and is indicated in STO 108, such as where the next location (e.g., intermediate location 104) in the planned TCD route 120. In one embodiment, a route guide engine (RGE) in an extended warehouse management (EWM) is used to have and obtain the necessary information to direct HUs throughout route 120 according to STO 108 (FIG. 1). Supplemental STOs may also be used for transportation of good for certain segments (e.g., from one intermediate location to another intermediate location) within route 120.

In one embodiment, RGE may include route distinguishing capabilities to distinguish between multiple available TCD routes based on various factors, thresholds, and/or criteria (e.g., lower cost, faster route, shorter route, urgency of order, customer preferences, type of goods, etc.) to help choose the most preferred TCD route. The most preferred TCD route may include a route preferred by a customer (although it may not be preferred by another customer and may not be the most efficient route), the most efficient route, the most cost-effective route, the least time-consuming route, and the like. Although customers may choose to provide certain preferences and/or requests for transportation of goods, it may not be necessary to duplicate these preference or requests, as the planning for the best TCD route may be done automatically and dynamically by TCD management.

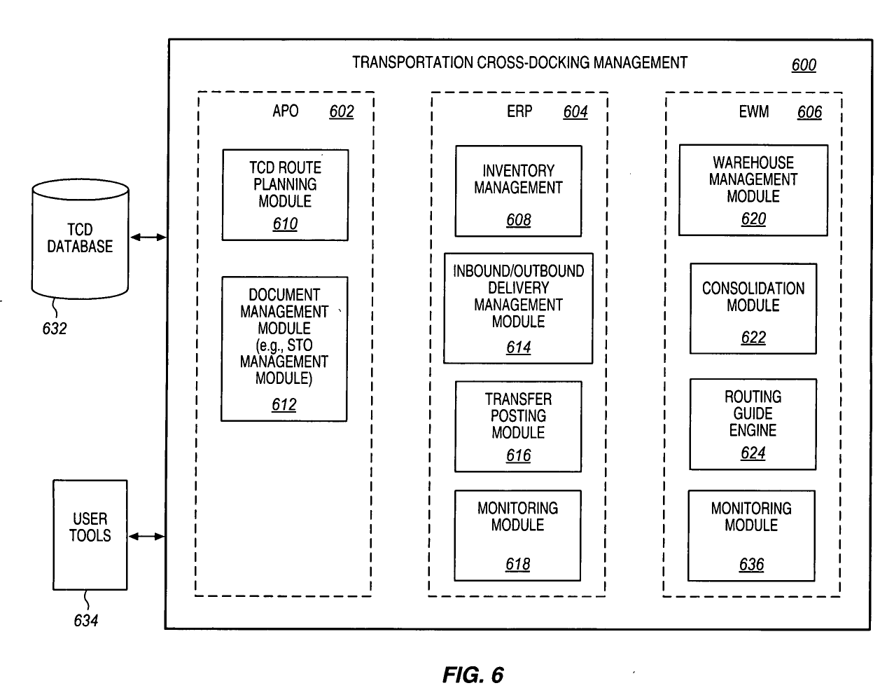

Also, as described with reference to FIG. 6, the movement of goods and related events within route 120 are monitored and/or tracked via monitoring module that is also part of TCD management. This monitoring module employs various monitoring techniques to provide an overview of the entire TCD process, such as to properly monitor route 120 and activities (e.g., HUs at a warehouse, HUs in-route to a warehouse, processes within a warehouse, shipment progress, etc.) therein. This monitoring mechanism may also be used to inform customers of the transportation status, such as via inquiry in the commercial system, transmitted packing list, transmitted Advanced Shipping Notification (ASN), etc. Furthermore, monitoring tools may also be employed at an EWM (as illustrated in FIG. 6) to provide an overview of the internal or inner warehouse activities of the TCD process.

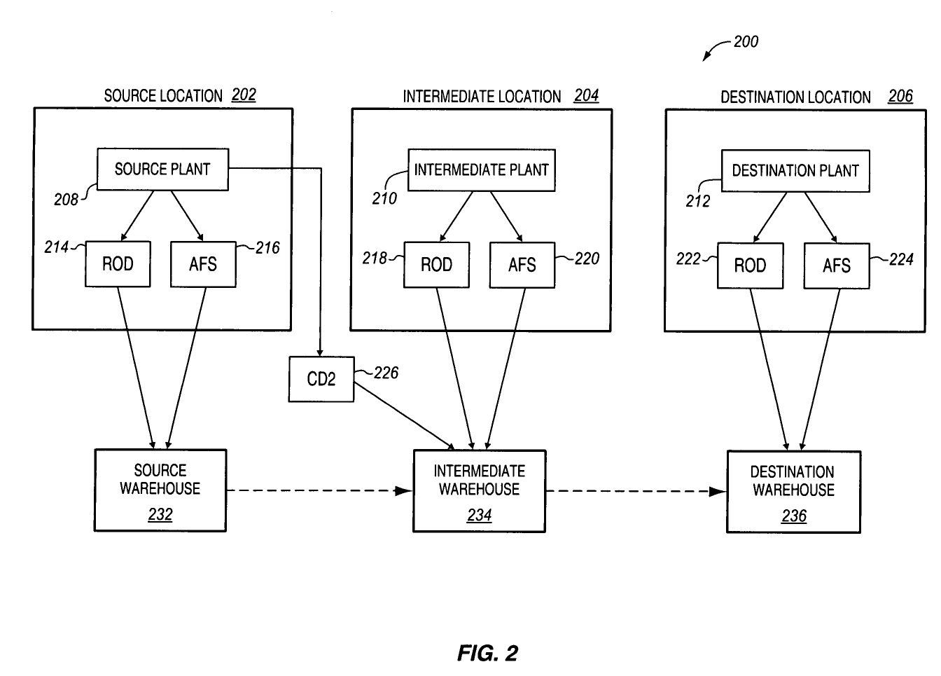

FIG. 2 illustrates one embodiment of an organizational structure 200 for transportation cross-docking. In one embodiment, TCD supports a process for planning and predetermining transportation of goods within a network of locations using deliveries (in- and outbound). These locations are predetermined based on various factors, events, and variables as discussed with reference to FIG. 1. A delivery may be generated having relevant information to not only indicate the TCD route that is assigned to the goods, but also to direct the goods in a proper direction within the route by leading the goods on the routing path and properly matching each relevant document such that thereafter, the goods are seamlessly moved to and from these locations, cross-docked at predetermined locations, and consolidated/deconsolidated at various locations as planned. There may also be other documents or additional deliveries to supplement the original deliveries in performing these tasks.

In the illustrated embodiment, organizational structure 200 for TCD includes source location 202, intermediate location 204, and destination location 206. Each location 202-204 includes a warehouse such as source warehouse 232, intermediate warehouse 234, and destination warehouse 236. Warehouses 232-236 are physical warehouses where goods are received and processed as they move from source warehouse 232 to destination warehouse 236 via intermediate warehouse 234 according to the in- and outbound deliveries. Each location 202-206 includes a plant, such as source plant 208, intermediate plant 210, and destination plant 212.

Each plant 202-206 is associated with a transfer or inventory bucket (bucket) 214-224 to provide the status of inventory, such as received on dock (ROD) and available for sale (AFS) after goods receipt. ROD and AFS indicate two types of representation of ownership and availability of inventory. There may be additional types of representation, such as somewhere in between ROD and AFS. Each bucket 214-224 is associated with its corresponding plant and warehouse, such as source buckets 214-216 are associated with source plant 208 and source warehouse 232, intermediate buckets 218-220 are associated with intermediate plant 210 and intermediate warehouse 234, and destination buckets 222-224 are associated with destination plant 212 and destination warehouse 236. To cross-dock between locations, such as between source location 202 and intermediate location 204, bucket 226 is provided for posting of inventory status and documents. Using organizational structure 200, the need for changing ownership for cross-docking goods is eliminated. Stated differently, there may not be a need to change the ownership of goods (e.g., no GI is necessary out of shipment) as they are transported from source warehouse 232 to intermediate warehouse 234 to destination warehouse 236 along a TCD route until they are regarded as GR in warehouse 236 when using an STO (or, for example, GI to a customer when using an SO).

In one embodiment, additional inventory buckets and/or transfer buckets may be assigned to organizational structure 200 to provide additional visibility of the movement of goods. For example, the movement, activities, and processes of goods (e.g., location at any given time, cross-docking status, etc.) may be visible via buckets 214-226 as they provide a visible flow of goods via inventory status and relevant documents throughout the planned TCD route until goods are GR posted at destination plant 212 when using an STO (or, for example, GI to a customer when using an SO).

The illustrated organizational structure 200 for transportation cross-docking includes the following segments: (1) source location 202 where an outbound delivery associated with goods may be generated and transportation of goods may be initiated; (2) intermediate location 204 where goods are “cross-docked”, “consolidated” and “passed through” to the next location in the TCD route according to a pair of in- and outbound deliveries (initiated by TCD management); and (3) destination location 206 is regarded as the final receiving facility and where the order for goods may have been placed and received using an inbound delivery. The dotted arrows indicate the movement of goods. As described elsewhere in this document, there may be multiple source locations, multiple intermediate locations, and/or multiple destination locations.

Outbound delivery may be generated at source location 202. At each of the locations 202-206, a call for TCD route may be made via EWM, serving the original STO, to move the outbound delivery to its intended subsequent location. For example, with a GI posting (e.g., in EWM or ERP), goods are reduced in bucket 214 as they are moved to “stock in transfer” status within a plant 208 at source location 202. The visibility provided in ERP for this stock in transfer can be the same as for any other regular movements between buckets 214-216 within plant 208. Further, transportation of goods includes (1) posting of stock in transfer between locations, such as source location 202 and intermediate location 204, by posting, for example, at bucket 226; (2) fulfilling STO requirements as expected GR may still be visible via the Advanced Planner and Optimizer (APO) via an STO; and (2) performing the next GR at the next location, such as intermediate location 204, while the final GR is posted at destination location 206. The visibility provided in ERP for this stock in transfer may be the same as for any other regular movements between plants 208-212.

Once the inbound delivery is received at intermediate location 204, a GR posting in ERP (from stock in transfer) is registered at bucket 226. Since intermediate location 204 is the last intermediate location before reaching the destination location 206, outbound delivery at intermediate location 204 is regarded as the last outbound delivery and is referred to the original STO, while the stock is still posted to “in transit” from source location 202 to destination location 206 (e.g., from source plant 208 to destination plant 212). Stated differently, the stock or financial posting occurs once the goods are received at destination location 206 from source location 202. GI from the last intermediate location 204 may trigger one or more of the following: (1) creation of inbound delivery for final destination location 206 with reference to and as indicated by STO; (2) posting of delivery in transit; (3) updating of planned availability of STO quantity in material management (MM)/APO; and (4) triggering of billing and export papers.

Delivery-related invoicing (e.g., billing documents) may be triggered at the last intermediate location 204 since it is there that final quantities are known. The invoicing may be based on any number of invoicing solutions, such as invoicing solution approach (ISA). Functionality of hazardous material management may also be provided by the deliveries as the relevant master data may be available at source facility 202 and/or any of the intermediate facilities 204. Further, source facility 202 may add any relevant information to the outgoing ASN, and such information may be passed through the entire route and used for display and printing purposes.

TCD route, goods, and processes may be tracked or monitored by evaluating deliveries using monitoring module at ERP system via the ERP standard functionality for STO and deliveries. Tracking information obtained via the ERP standard may be communicated to CRM and be visible in the document flow of the customer order. For example, one or more of the following TCD processes may be visible in and communicated to CRM: (1) order issued from source location 202 to intermediate location 204; (2) checked delivery released to warehouse 234 of intermediate location 204; (3) GI for the checked delivery at intermediate warehouses 234 of intermediate location 204; (4) GR for the checked delivery at intermediate location 204; and (4) goods shipped from intermediate location 204. Also, for example, route information may be forwarded by EWM to ERP, while detailed information about execution processes (e.g., ship methods and HU details) may be looked up locally at EWM.

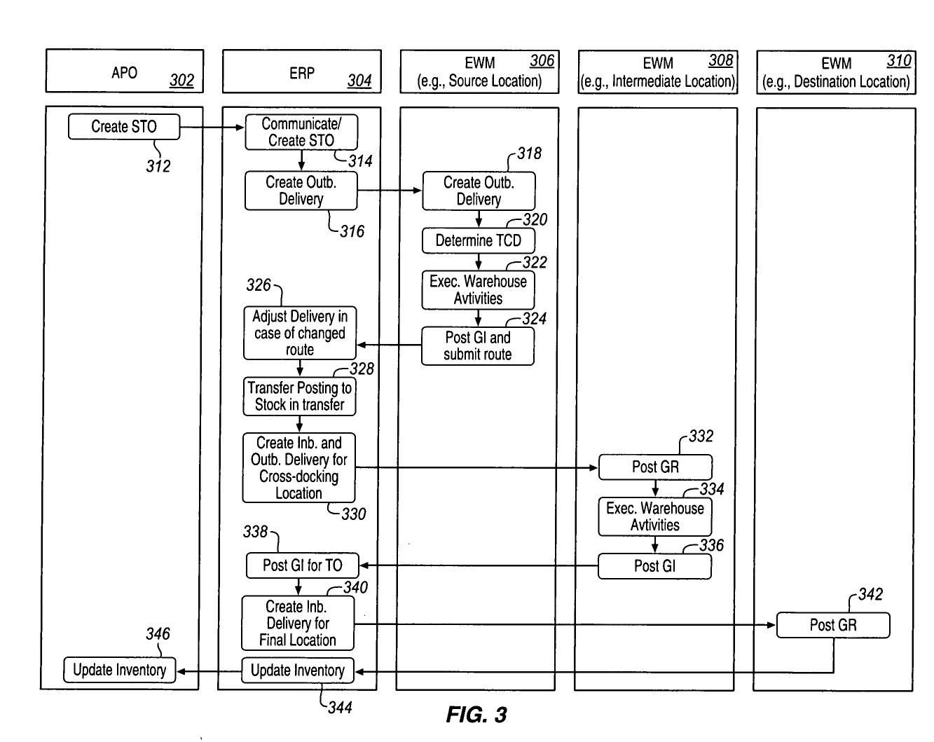

FIG. 3 illustrates an embodiment of a transactional sequence 300 for transportation cross-docking. At APO 302, a STO is created 312 that is associated with goods to be transported from a source location to an intermediate location to a destination location. The STO may also include other information relating to TCD route, activities, and processes. The newly generated STO is communicated to and/or regenerated 314 via ERP 304. Also via ERP 304, an outbound delivery is created 316 according to the STO. Outbound delivery is replicated at or communicated 318 to EWM 306 at source location. In one embodiment, APO 302, ERP 304, and EWM 306 may each be part of transportation cross-docking management and located at one or more machines and/or locations. For example, APO 302 may be part of SAP's SCM, while ERP 304 may represent SAP's R/3 enterprise, which may be R/3 plugged-in with SCM. Also, for example, APO 302 and ERP 304 may reside at a source location, while EWM 306-310 may reside at each of the locations involved in TCD route, such as EWM 306 residing at source location, EWM 308 residing at intermediate location, and EWM 310 residing at destination location.

At EWM 306, a TCD route is determined 320. This route, as discussed elsewhere in this document, may be chosen based on various factors (e.g., cost, time, distance, type and expected life of goods, customer requests and needs, weather, available routes, etc.). Various internal warehouse activities (e.g., movement of documents and goods, picking and packing of goods, etc.) for goods are performed 322. Then, a GI is posted and a TCD route is submitted 324 via EWM 306. At ERP 304, the delivery is checked for route, and inventory, etc., such that any adjustments in deliveries (e.g., due to a changed route) are made 326. Posting of goods is transferred to “stock in transfer” 328 as goods are expected to be transferred once this level is reached. A pair of inbound and outbound deliveries for the next TCD location is created 330 via ERP 304, such as an outbound delivery is created for leaving a source location and a pair of inbound and outbound deliveries is created for an intermediate location. These inbound and outbound deliveries may be communicated to the next TCD location, for example from ERP 304 at source location to EWM 308 at the next intermediate location.

A GR is posted 332 via EWM 308. Various internal warehouse activities for goods are executed 334. A GI is posted 336 via EWM 308. The GI is also posted 338 via ERP 304. Inbound delivery is created 340 for destination location via ERP 304 at source location and is communicated to destination location via EWM 310. A corresponding GR is posted 342 via EWM 310 at destination location and the inventory is updated 344 at ERP 304 and finally, the inventory is updated 346 via APO 302.

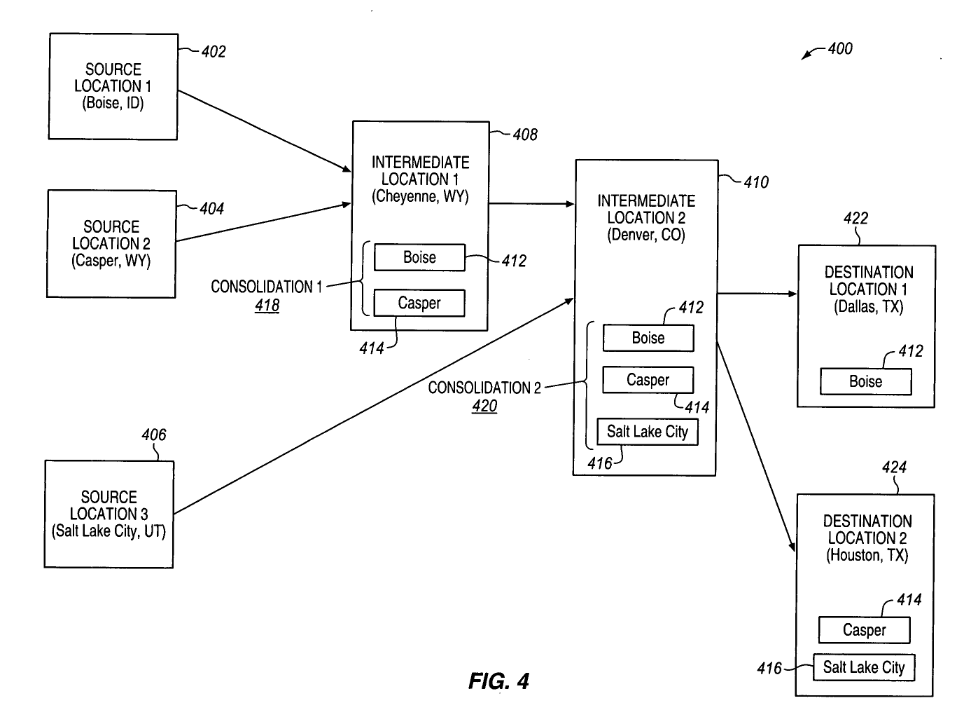

FIG. 4 illustrates an embodiment of a TCD route 400 for transportation cross-docking. In the illustrated embodiment, goods are routed from source locations 402-406 to destination locations 422-424 via intermediate locations 408-410. Goods may be associated with deliveries that indicate the routing of the goods. Deliveries may provide information relating to the routing of goods via transportation cross-docking route 400 as planned prior to the actual routing of goods. Source locations 402-406 include source location 1 402 (e.g., Boise, Id.), source location 2 404 (e.g., Casper, Wyo.), source location 3 406 (e.g., Salt Lake City, Utah). Intermediate locations 1-2 408-410 include intermediate location 1 408 (e.g., Cheyenne, Wyo.) and intermediate location 2 410 (e.g., Denver, Colo.). Destination locations 1-2 422-424 include destination location 1 422 (e.g., Dallas, Tex.) and destination location 2 424 (e.g., Houston, Tex.).

TCD route 400 includes various linear and non-linear routes to link various locations 402-410, 422-424. For example, a linear route is one that connects a single location (e.g., source location 402) to another single location (e.g., intermediate location 408). A non-linear or TCD route includes two or more linear routes, such as a combination of linear routes including a first linear route connecting source location 402 with intermediate location 408 and a second linear route connecting intermediate location 408 with intermediate location 410 and/or a third linear route connecting intermediate location 410 with destination location 422. In one embodiment, a link between incoming goods and outgoing good is established prior to the actual arrival of incoming goods and the release of outgoing goods once each of the linear routes are known as indicated by an STO. Similarly, necessary processes or execution of goods may also be predetermined and relevant information for such processes may be provided by deliveries.

At intermediate location 408, deliveries of goods from source locations 402404 may be cross-docked and consolidated 418 into a common shipment. Similarly, deliveries of goods from source location 406 may be cross-docked at intermediate location 410 where they are consolidated 420 with deliveries from source locations 402-406 in yet another common shipment. Goods may then be delivered to one or more destination locations 422-424 as planned. Goods from intermediate location 410 may be consolidated 418-420 and/or deconsolidated into segments with each segment being delivered to the corresponding destination location 422-424 as described in the deliveries. For example, goods from Boise 412, i.e., from source location 402, may be delivered to destination location 422, while goods from Casper 414, i.e., from source location 404, and Salt Lake City 416, i.e., from source location 406, may be delivered to destination location 424 as directed by the corresponding STO.

In one embodiment, goods may be further divided as planned, such as Casper 414 may be sent partially to destination location 422, partially to destination location 424, and partially to another destination. The consolidation 418-420 and/or deconsolidation of goods may be based on HUs (e.g., by consolidating/deconsolidating HUs). For example, some HUs may be transferred to destination location 422, while other HUs may go to destination location 424. Also, since a bigger/outer HU may contain one or more smaller/inner HUs, the outer or top HU along with some of the inner HUs may be transported to destination location 424, while some of the remaining inner HUs may be transported to destination location 422. Any predetermined combination of goods may be transported to any number of destination locations 422-424.

Several HUs may be received to be delivered at an intermediate location 408-410 as the intermediate location is the final destination location for such HUs. For example, some of the HUs from Boise 402 are not cross-docked in Cheyenne 408, but instead, they are delivered there. Similarly, another set of HUs from Boise 402 are delivered in Denver 410 without being cross-docked there (but, cross-docked in Cheyenne 408), while the rest are delivered in Dallas 422 after being cross-docked in Cheyenne 408 and Denver 410. Stated differently, not all goods are required to be shipped to destination locations 422-424 and for such goods an intermediate location 408-410 is the final destination location. The predetermined TCD route 400 indicates cross-docking of goods at intermediate location 408-410. The cross-docking of goods at intermediate location 408-410 may be performed without putting the goods away at intermediate location 408-410 Furthermore, generating the warehouse task with reference to the TCD deliveries includes specifying one or more of cross-docking tasks including one or more of receiving of goods, issuing the goods, processing of goods, consolidating of goods, deconsolidating of goods, and any cross-docking tasks to be performed without putting the goods away at intermediate location 408-410.

As described elsewhere in this document, HU represents one or more items of a particular good for routing within a predetermined TCD route 400. For example, HU may include a truck, package, a box, a cart, a pallet of knobs, etc. The size of an HU may depend upon the particular warehouse, the purpose of the move, the size of an incoming or outgoing delivery, etc. HUs may include additional one or more HUs that may include even more HUs, such a box within a box within a box, a truck having big boxes containing smaller packages, etc. One or more HUs can be combined in bundle, which represents a group of goods for movement to a next location in a route 400. In one embodiment, bundle consists of one or more of the same kind of HUs. In one embodiment, bundle may include multiple HUs, which may be of varying types, which have a common next location in a routing path. A bundle may be built for moving from source locations 402-406 and stays together along the entire route 400 to destination locations 422-424.

At source location 402-406, original STOs may be generated, indicating the destination location 422-424 of HUs for purposes of the route 400 in question. Destination locations 422-424 for goods for the purposes of a routing path 400 do not necessarily indicate that the goods will not be moved again in the life of the goods. Original STOs can be associated with HUs, for example, via an identifier included within the original STOs identifying HUs. The identifier can be any identifier known in the art, and may be generated at source destination 402-406, such as name or number or alpha-numeric identifier assigned to goods (incoming or outgoing), a bar code, a part number, an RFID, a serial number, etc. Identification of goods may or may not identify the quantity of goods.

To move HUs, a management engine, such as routing guide engine (RGE), may help determine and/or direct a planned routing path for a particular HU. For example, RGE may determine and/or direct that, as planned, an HU at source location 402 does not go directly from intermediate location 408 to destination location 422, but it has a next routing event at intermediate location 410.

Planned TCD provides leaner, more flexible, and accelerated supply chain that is based on predefined criteria, known needs, expected work load, matching of inbound deliveries with outbound deliveries, etc., rather than the conventional way of being based on opportunistic, random, and/or do-as-you-go transportation. TCD route 400 along with consolidation 418-420 of goods may optimize flow of goods from inbound receipts to outbound demands, eliminate interim storage needs, reduce warehouse execution tasks, improve warehouse operations management in terms of capacity, make more visible the work flow and supply chain execution optimization opportunities, monitor the movement of goods, etc.

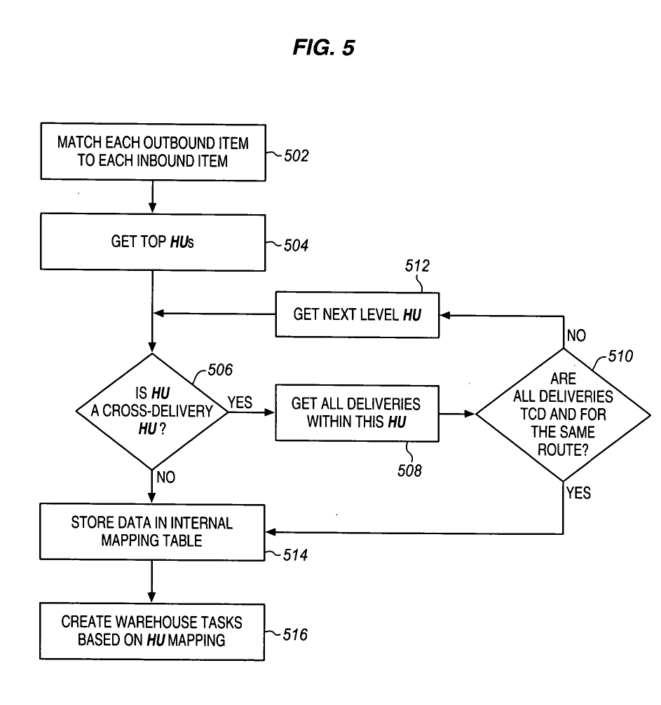

FIG. 5 illustrates an embodiment of a process for generation of a warehouse task (WT) and allocation of goods using TCD mapping data. In one embodiment, goods for TCD may be allocated, consolidated/deconsolidated, and/or transported based on the mapping between inbound and outbound deliveries as planned. Such mapping of inbound and outbound deliveries includes finding or matching an outbound delivery item for each inbound delivery item at processing block 502. At processing block 504, top HUs are obtained. As described with reference to FIG. 4, a single HU may contain one or more HUs and these HUs may be cross-docked and delivered at various intermediate locations and destination locations, respectively. At decision block 506, a determination is made as to whether any of the top HUs is regarded as cross-delivery HU. If a top HU is not a cross-delivery HU, relevant information is stored as mapping data in a mapping table at processing block 514 as this HU is then identified as relevant for the cross-docking process. Using the mapping data from the mapping table, HU mapping is determined and a corresponding WT is generated at processing block 516. The WT may then be used for movement and allocation of goods within a planned TCD route.

Referring back to decision block 506, if a top HU is regarded as a cross-delivery HU, other HUs and/or deliveries within that HU are obtained at processing block 508. Whether all other deliveries of goods are TCD deliveries and are for the same TCD route is determined at decision block 510. If these deliveries are TCD deliveries and are for the same the TCD route, the deliveries are consolidated and the relevant information about the deliveries is stored as mapping data in the internal mapping table at processing block 514. The mapping data is then used to generate WTs at processing block 516. Have all deliveries for the same TCD route may refer to HUs or deliveries having the same TCD attributes (e.g., departure date, intermediate location, etc.) as described in original delivery documents, such as an STO. Also, these deliveries are not regarded as multiple deliveries as they share the same TCD route attributes, such as they are routed to the same intermediate location or destination location.

Referring back to decision block 510, if the deliveries within the identified HU are not TCD deliveries and/or are not for the same TCD route (e.g., do not share the same TCD attributes), the next level HU is then obtained at processing block 512. This is because having different TCD attributes means the deliveries or HUs are to be properly allocated (including consolidation, reconsolidation, deconsolidation, etc.) for the deliveries to be correctly identified and transported. Having different TCD attributes may mean a difference of one or more of delivery time, delivery date, different intermediate locations, different destination locations, etc.

FIG. 6 illustrates an embodiment of transportation cross-docking management 600. TCD management 600 provides several elements, components, and/or modules for transportation cross-docking. For example, TCD management 600 includes APO 602, ERP 604, and EWM 606, each of which contains various modules and sub-modules 608-624 to perform various TCD-related tasks, such as generating, creating, and/or modifying of STOs and deliveries associated with goods to help plan and enable movement of goods between source, intermediate and destination locations. In one embodiment, APO 602 is optional and may not be included in TCD management 600. Although certain modules are illustrated, TCD management 600 may include more or fewer modules or components than what is depicted. Further, the modules may be collectively or individually interconnected. The interconnecting of the modules may be through a bus or other communication medium and/or through the use of application interfaces or function calls. Thus, the modules can be considered to be coupled to one or more other modules through the interconnections.

APO 602 may be referred to a supply chain component that provides the abilities and functionalities for planning and scheduling of transportation cross-docking. APO 602 receives, manages, and responds to requests for the movement of goods from one location to another, such as from source location to intermediate location to destination location, using user input via user interface and tools 634. Such requests and other information (e.g., goods-related information, warehouse information, TCD route information, etc.) may be stored at TCD database 632. ERP 604 maintains and uses inventory information via inventory management 608. Inventory information may include information about goods, such as type of goods (e.g., batteries, fans, toasters, etc.), nature of goods (fragile, bulky, etc.) quality of goods (excellent, good, pre-used, etc.) and quantity of goods (e.g., number or weight of items available, unavailability, etc.) currently at various locations (e.g., source location, intermediate location, other warehouses, etc.).

Inventory information and other relevant information and/or criteria (e.g., customer/user inputs and/or requests, weather, route tolls, route distance, route terrain, minimum/maximum speeds, mapping data at mapping table, and history of particular customers, goods, and routes, etc.) are taken into consideration at APO 602 to plan an appropriate TCD route for movement of goods via TCD route planning module 610. Planning of a TCD route includes predetermining intermediate locations, scheduling of the movement of goods, consolidation of goods, etc., before the actual movement of goods as indicated in STOs. Document management module 612 is used for generating and managing any number of corresponding documents (e.g., stock transport orders, sales orders, warehouse tasks, etc.) for the movement of goods. For example, document management module 612 includes an STO management module that generates and manages STOs for the movement of goods. The STOs may be generated based on inventory information and other relevant information and/or criteria, as described earlier. STO management module 612 may also generate and/or populate various fields of a STO for a movement of goods. In one embodiment, STOs may be stored at TCD database 632 and/or a memory for more persistent maintenance. Deliveries may be generated for each move along a TCD route, such as a new delivery or a modified delivery may be generated at each intermediate location, as planned. Also, various deliveries may identify the same goods, and be referring to different locations along a TCD route.

The STOs may be generated in response to a request, after, or in conjunction with, TCD route planning module 610 for determining a TCD route for goods. STO management module 612 may also refer to the ability of TCD route panning module 610 to route goods with the separate STOs created. Also, with multiple STOs referring to the same goods, TCD route planning module 610 can distinguish between different routing events for the goods, can track the goods, and/or handle the posting of information on confirmation of STO/deliveries when goods arrive appropriately at a location.

ERP 604 includes an operation and execution system to propose cross-docking in subsequent warehouses (e.g., at each intermediate level) to continue proper movement of goods. Inbound/outbound delivery management module 614 creates TCD inbound and outbound deliveries which model the goods movement into and from cross-docking warehouses. An outbound delivery may be referred to as picking from inbound delivery related stock or goods. Thus, inbound and outbound deliveries are matched, maintained, and updated together to manage a match between each inbound delivery and each outbound delivery. This mapping between inbound and outbound deliveries is maintained in an internal mapping table that is managed by inbound/outbound delivery management module 614 and maintained and stored at TCD database 632. This mapping table is then used by warehouse management module 620 to generate Pick HU-Warehouse Tasks. Also, material management (MM) module (not shown) at ERP 604 may be in communication with APO when creating deliveries or when duplicating or communicating deliveries. An example of ERP 604 includes SAP R/3 Enterprise by SAP AG of Walldorf, Germany.

Transfer posting module 616 provides transfer postings to goods in transfer to update the inventory being managed by inventory management 608. Transfer posting relates to posting of information as the goods are moved from one location (e.g., posting of GI) to another location (e.g., posting of GR) so that the inventory of goods is continuously updated and balanced. Monitoring module 618 at ERP 604 supports monitoring of the process of the movement of goods throughout the entire chain of a TCD route. Similarly, monitoring module 636 at EWM 606 may also be used to support monitoring of the movement of goods throughout the entire chain of a TCD route. Such monitoring may also include tracking of goods as they move from warehouse to warehouse using various monitoring techniques.

EWM 606 supports the movement of goods by facilitating the movement of HUs from one location to another via RGE 624. For example, EWM 606 supports picking of HUs of cross-docking outbound deliveries directly from the goods receipt area of the cross-docking inbound deliveries. In other words, RGE 624 at EWM 606 has the necessary information to direct HUs from source location to destination location via intermediate cross-docking locations within a TCD route. In one embodiment, various components may be located on different machines or at different locations, such as each warehouse or location may have a local version of EWM 606, while other components, such as APO 602, ERP 604, etc., may reside at a different location, such as source location. In another embodiment, the entire transportation cross-docking management 600 may reside at a single location, such as source location. Using warehouse tasks, warehouse management module 620 may also control internal warehouse moves of HUs that are inside various warehouses.

Consolidation module 622 provides consolidation of HUs as planned to consolidate goods at various locations in accordance with a deliveries. Consolidation module 622 may also provide deconsolidation of goods. Consolidation module 622 may further provide management of various HU, such as goods are combined to form a routing group that may be an HU or a group identifiable by an identifier and trackable with an STO. Warehouse management module 620 manages the internal routing management of goods, such as movements and processes of goods within a warehouse using warehouse tasks. User tools 634 are accessed with one or more user interfaces to provide access to and interaction with TCD management 600. Using user tools 634, for example, an employee may confirm receipts of goods at a warehouse, a manager may interact with warehouse internal activation plan, a customer may place requests and/or feedback and receive responses, an administrator or programmer may create, delete, and/or update various components of TCD management 600. User tools 634 include various Graphical User Interface (GUI) tools to permit easier interaction between a user and TCD management 600.

Transportation cross-docking management 600 may also include supply chain event management (SCEM) (not shown) to provide better visibility and recognition of HUs, inventory collaboration hub (ICH) (not shown) to maintain information relating to warehouses and other inventory hubs. SCM base (not shown) may also be added to include the functionalities of SCM components, such as APO 602, EWM 606, SCEM, ICH, etc., such that the SCM components may be migrated to SCM base and conversely, SCM base can be used by all the SCM components.

One or more modules within or associated with TCD management 600 may include hardware, software, and/or a combination of these. In a case where a module includes software, the software data, instructions, and/or configuration may be provided via an article of manufacture by a machine/electronic device/hardware. An article of manufacture may include a machine accessible/readable medium having content to provide instructions, data, etc. The content may result in an electronic device, for example, a filer, a disk, or a disk controller as described herein, performing various operations or executions described. A machine accessible medium includes any mechanism that provides (i.e., stores and/or transmits) information/content in a form accessible by a machine (e.g., computing device, electronic device, electronic system/subsystem, etc.). For example, a machine accessible medium includes recordable/non-recordable media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.), etc. The machine accessible medium may further include an electronic device having code loaded on a storage that may be executed when the electronic device is in operation. Thus, delivering an electronic device with such code may be understood as providing the article of manufacture with such content described above. Furthermore, storing code on a database or other memory location and offering the code for download over a communication medium via a propagated signal may be understood as providing the article of manufacture with such content described above.

In addition to what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A method, comprising:
predetermining a route for transportation of goods from a source location to an intermediate location to a destination location; and
generating a document associated with the goods, the document indicating the predetermined route and including cross-docking at the intermediate location.

2. The method of claim 1, wherein the predetermining of the route comprises:
evaluating one or more of customer history, customer requests, history of goods, types of goods, quantity of goods, quality of goods, available routes, available handling units, cost restrictions, and time restrictions.

3. The method of claim 1, further comprising generating deliveries based on the document, the generating of the deliveries comprises:
specifying at least one cross-docking task including one or more of receiving the goods, issuing the goods, processing the goods, consolidating the goods, deconsolidating the goods, and any cross-docking tasks to be performed without putting the goods away at the intermediate locations.

4. The method of claim 1, wherein the document comprises:
a stock transport order.

5. The method of claim 1, further comprising:
determining mapping information based on matching of inbound deliveries and outbound deliveries.

6. The method of claim 5, further comprising:
populating a mapping table with the mapping information, the mapping table being stored at a database and accessed to generate warehouse tasks via the mapping information.

7. The method of claim 6, wherein the generating of the warehouse tasks comprises:
specifying tasks to be performed on one or more handling units of the goods, the handling units including one or more of vehicles, pallets, boxes, carts, and packages.

8. A transportation cross-docking system, comprising:
a route planning module to predetermine a route for transportation of goods from a source location to an intermediate location to a destination location; and
a management module to generate a document associated with the goods, the document indicating the predetermined route and including cross-docking at the intermediate location.

9. The system of claim 8, wherein the route planning module comprises:
logic to evaluate one or more of customer history, customer requests, history of goods, types of goods, quantity of goods, quality of goods, available routes, available handling units, cost restrictions, and time restrictions

10. The system of claim 8, wherein the management module comprises:
logic to specify at least one cross-docking task including one or more of receiving the goods, issuing the goods, processing the goods, consolidating the goods, deconsolidating the goods, and any cross-docking tasks to be performed without putting the goods away at the intermediate location.

11. The system of claim 8, wherein the management module comprises:
logic to specify tasks to be performed on one or more handling units of the goods, the handling units including one or more of vehicles, pallets, boxes, carts, and packages.

12. The system of claim 8, further comprising:
a graphical user interface to permit one or more of viewing the deliveries, accessing the document, and modifying the document, wherein the document includes a stock transport order.

13. A transportation cross-docking apparatus, comprising:
means for predetermining a route for transportation of goods from a source location to an intermediate location to a destination location; and
means for generating a document associated with the goods, the document indicating the predetermined route and including cross-docking at the intermediate location.

14. The apparatus of claim 13, wherein the means for predetermining the route comprises:
means for evaluating one or more of customer history, customer requests, history of goods, types of goods, quantity of goods, quality of goods, available routes, available handling units, cost restrictions, and time restrictions.

15. The apparatus of claim 13, further comprising means for generating deliveries based on the document, wherein the means for generating the deliveries comprises:
means for specifying at least one cross-docking task including one or more of receiving the goods, issuing the goods, processing the goods, consolidating the goods, deconsolidating the goods, and any cross-docking tasks to be performed without putting the goods away at the intermediate location.

16. The apparatus of claim 13, wherein the document comprises:
a stock transport order.

17. An article of manufacture comprising a machine-accessible medium having instructions which when executed cause a machine to:
predetermine a route for transportation of goods from a source location to an intermediate location to a destination location; and
generate a document associated with the goods, the document indicating the predetermined route and including cross-docking at the intermediate location.

18. The article of manufacture of claim 17, wherein instructions causing the machine to predetermine comprises instructions to cause the machine to:
evaluate one or more of customer history, customer requests, history of goods, types of goods, quantity of goods, quality of goods, available routes, available handling units, cost restrictions, and time restrictions.

19. The article of manufacture of claim 17, wherein the instructions which when executed further cause the machine to generate deliveries based on the document,
wherein instructions causing the machine to generate deliveries comprise instructions to cause the machine to:
specify at least one cross-docking task including one or more of receiving the goods, issuing the goods, processing the goods, consolidating the goods, deconsolidating the goods, and any cross-docking tasks to be performed without putting the goods away at the intermediate location.

20. The article of manufacture of claim 17, wherein the document comprises a stock transport order.
